(19) United States
(12) Patent Application Publication
(10) Pub. No.: US 2019/0065404 A1
(43) Pub. Date: Feb. 28, 2019

(54) ADAPTIVE CACHING IN A STORAGE DEVICE

(71) Applicant: Seagate Technology LLC, Cupertino, CA (US)

(72) Inventors: Nitin Satishchandra Kabra, Pune (IN); Rajesh Maruti Bhagwat, Pune (IN); Jackson Ellis, Fort Collins, CO (US); Geert Rosseel, La Honda, CA (US)

(21) Appl. No.: 15/691,193

(22) Filed: Aug. 30, 2017

(51) Int. Cl. G06F 12/128; G06F 12/0897

(52) U.S. Cl. CPC G06F 12/128; G06F 12/0877; G06F 12/0897

(57) ABSTRACT

Implementations described and claimed herein provide a method and system for adaptive caching in a storage device. The method includes receiving an adaptive caching policy from a host for caching host read data and host write data in a hybrid drive using NAND cache, and allocating read cache for the host read data and write cache for the host write data in the NAND cache based on the adaptive caching policy. In some implementations, the method also includes iteratively performing an input/output (I/O) profiling operation to generate an I/O profile. An adaptive caching policy may be applied based on the I/O profile. When a unit time has completed, a new I/O profile may be compared with a current I/O profile. A new adaptive caching policy is applied based on determining the new I/O profile is different than the current I/O profile.

### BACKGROUND

Data storage systems include data storage areas or locations serving as transient storage for host data for the purposes of performance or reliability enhancement of the device. Such temporary storage areas may be non-volatile and may be referred to as a cache. A storage controller of such data storage systems may use the various levels and types of cache to store data received from a host, cache read data from other, higher latency tiers of the storage device, and generally to improve the device performance.

A hybrid drive storage device may utilize technology of one or more hard disk drives (HDDs) (e.g., having rotating magnetic or optical media), and one or more solid-state drive (SSDs) that may be used as cache space. The HDD of a hybrid drive includes high capacity storage media for storing data for extended periods of time due to high read/write latency compared to the SSD caches. SSDs are generally fast access and as such the SSDs of the hybrid drive are used to hold cache data, data that is frequency/recently accessed, or important data (e.g., boot data). As such, hybrid drives are also referred to as solid-state hybrid drives (SSHDs), because they combine HDD technology and SSD technology to leverage advantages of cost and speed. In some implementations, the SSD of the hybrid drive may use NAND memory as a cache for the HDD.

### SUMMARY

Implementations described and claimed herein provide a method and system for adaptive caching in a storage device. The method includes receiving an adaptive caching policy from a host for caching host read data and host write data using NAND cache, and allocating read cache for the host read data and write cache for the host write data in the NAND cache based on the adaptive caching policy. In some implementations, the method also includes iteratively performing an input/output (I/O) profiling operation to generate an I/O profile. An adaptive caching policy may be applied based on the I/O profile. When a unit time has completed, a new I/O profile may be compared with a current I/O profile. A new adaptive caching policy is applied based on determining the new I/O profile is different than the current I/O profile.

This Summary is provided to introduce a selection of concepts in a simplified form that are further described below in the Detailed Descriptions. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Descriptions of various implementations as further illustrated in the accompanying drawings and defined in the appended claims. These and various other features and advantages will be apparent from a reading of the following Detailed Descriptions. Other implementations are also described and recited herein.

### BRIEF DESCRIPTIONS OF THE DRAWINGS

FIG. 1 illustrates a block diagram of an example adaptive cache controller system.

FIGS. 2A-F are schematic diagrams illustrating example NAND cache capacity management operations.

FIGS. 3A-B are tables illustrating endurance vs. performance throttling without and with offset.

FIG. 4A-4C illustrates example schematic diagrams of I/O profiling classification.

FIG. 5 illustrates a flow chart of example operations for I/O profiling.

FIG. 6 illustrates a flow chart of example operations for adaptive caching.

FIG. 7 illustrates a block diagram of an example computer system suitable for implementing the adaptive caching technology disclosed herein.

### DETAILED DESCRIPTIONS

A storage controller in a storage device can receive numerous data workload profiles (e.g., sequential writes, sequential reads, random writes, random reads, and combinations of these operations) and non-data workload profiles (e.g., management control and status) from a host computer. To manage these data and non-data workload profiles, a storage device may utilize all-flash array solutions, which implement solid-state drive (SSD) storage, or a host server implementing a complex computing engine to redistribute data depending on its temperature (e.g., hot, warm, cold, etc.) inside a hybrid storage array. Both solutions can be costly. Further, as the nature of these types of workloads is not constant, the overall performance may be degraded. Complex hardware and firmware engine running on storage or file servers may be used for servicing random and mixed workloads. Application data may reach a final storage area/volumes through centralized caching funnel inside the storage or file servers and ultimately, result in a bottleneck.

The disclosed technology involves funneling various application data separately at separate node storage volumes by managing read caching, write caching, and auto-tiering based on the temperature of data in a hybrid drive system.

A hybrid drive may be defined as a minimum of two independent non-volatile storage media with one of the media acting as fast high-speed media and the other media acting as high capacity relatively slower media. Each media may be connected on an independent interconnect (e.g., ONFI, SATA, SAS, PCIe, etc.). The host interface of the disclosed hybrid drive may be of any type (e.g., SAS, SATA, PCIe, etc.) independent of the interface used on each non-volatile storage media (e.g., Magnetic platter, NAND Hash, XPOINT, ReRAM, MRAM, or any similar future technology). The following are examples of a hybrid drive: 1) solid-state drive (SSD)+hard disk drive (HDD) with SAS/SATA/PCIe HOST interconnect and SAS/SATA/PCIe HDD Interconnect; 2) SSD(SLC/MLC/TLC)+SSD(TLC/QLC) with SAS/SATA/PCIe HOST interconnect and SAS/SATA/PCIe HDD Interconnect. Other configurations are contemplated.

Specifically, the disclosed technology includes an adaptive cache controller that allocates read and write NAND cache based on adaptive caching policies. The adaptive caching policies can be tailored by performing intelligent I/O profiling operations. The distribution of read and write caching capacity is dynamically varied to obtain an equilibrium by increasing endurance and performance, and thus, workloads on the storage/files servers are reduced.

Data storage and/or memory may be embodied by various types of storage, such as hard disk media, a storage array containing multiple storage devices, optical media, solid-state drive technology, ROM, RAM, and other technology. The operations may be implemented in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

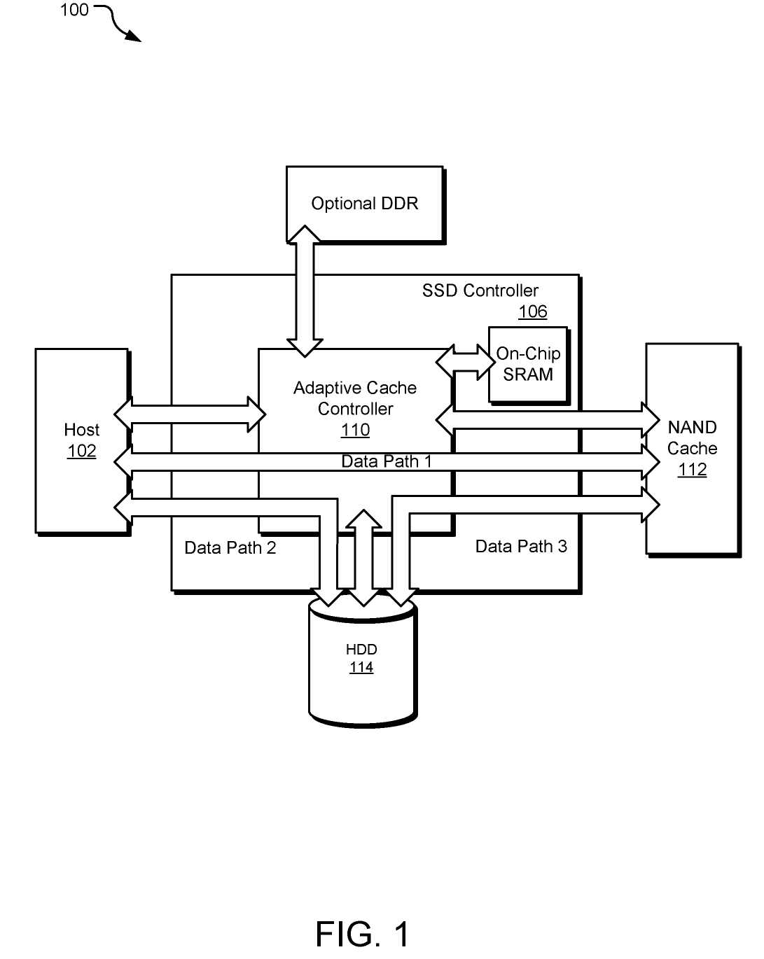

FIG. 1 is a block diagram of an example adaptive cache controller system 100. An adaptive cache controller 110 in a hybrid drive system 154 is communicatively connected to a host 102. The host 102 transmits data access commands (e.g., read commands, write commands) to the adaptive cache controller 110. As illustrated, the adaptive cache controller 110 is implemented in firmware with required infrastructure in the hardware. The firmware runs inside a CPU subsystem. In some implementations, the adaptive cache controller 110 may be internal or external to other components in the adaptive cache controller system 100, such as solid-state storage media and disc media.

The adaptive cache controller system 100 may incorporate NAND cache (e.g., NAND Cache 112) or other forms of non-volatile memory technology to store data and acts as a read/write cache to a drive (e.g., HDD 114). In some implementations, the drive may be an SSD, or other future technology drive. Such read/write data may include frequently or recently accessed data as well as recently received data (e.g., from the host 102). Such data may be referred to as ‘hot’ data. Data stored on an SSD may also include boot data or data awaiting transfer to the HDD 114.

The adaptive cache controller system 100 may include multiple SSDs and/or multiple HDDs. The adaptive cache controller 110 via the storage controller (e.g., an SSD controller 106) may include instructions stored on a storage media and executed by a processor (not shown) to receive and process data access commands from the host 102.

An adaptive caching policy may be determined by the host 102, which may set limits on the caching utilization. The host 102 may configure read and write caching capacities and percentage of read and write transfer via cache. In some implementations, the adaptive cache controller 110 may have default settings for configurations for read and write caching capabilities and percentage of read and write transfers via cache at the beginning of operations and later an adaptive cache controller operation can vary the configurations to achieve a desired goal related to the optimum NVM media endurance and IO performance.

The adaptive cache controller 110 can vary the percentage of read I/Os and write I/Os that are cached based on self-learning I/O profiling operations and/or based on the host 102 imposing I/O profiling settings to reach optimum caching behavior for optimal performance and NAND endurance.

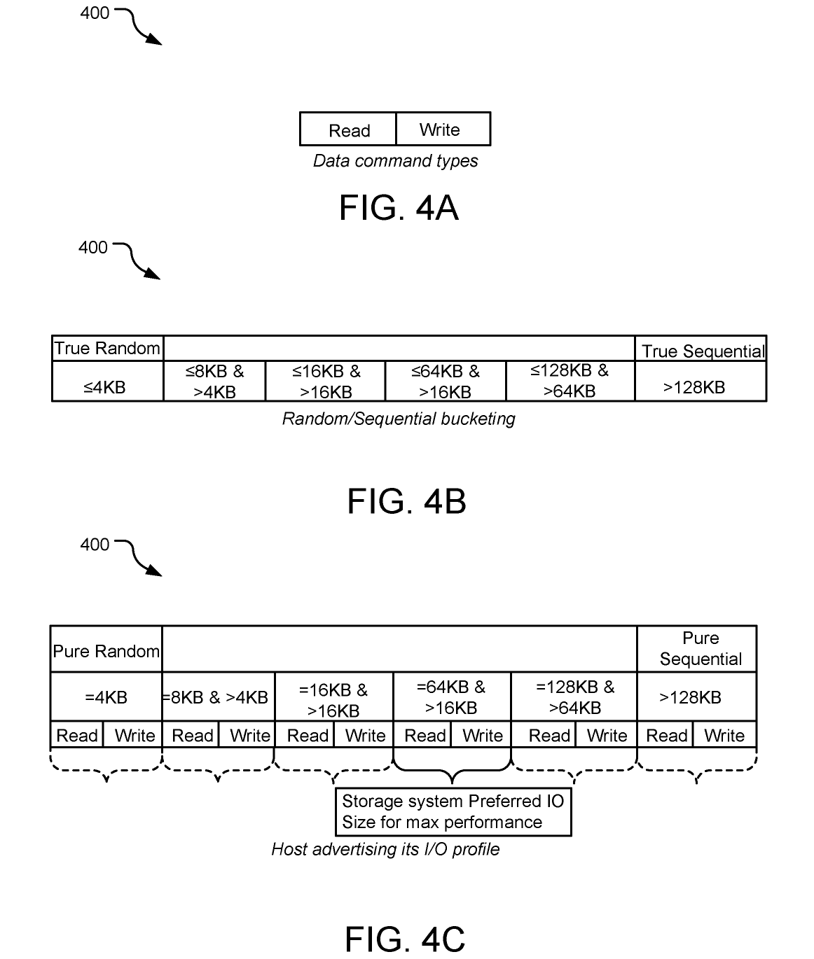

The adaptive cache controller 110 (or the host 102, depending on the implementation) can also profile I/O interims of block size. For example, the adaptive cache controller 110 can dedicate more caching resources for I/Os (read and/or write) within specific block size range depending upon a storage system host issuing I/O of specific size to maximize system performance. Such I/O profiling operations are described in more detail in FIG. 4.

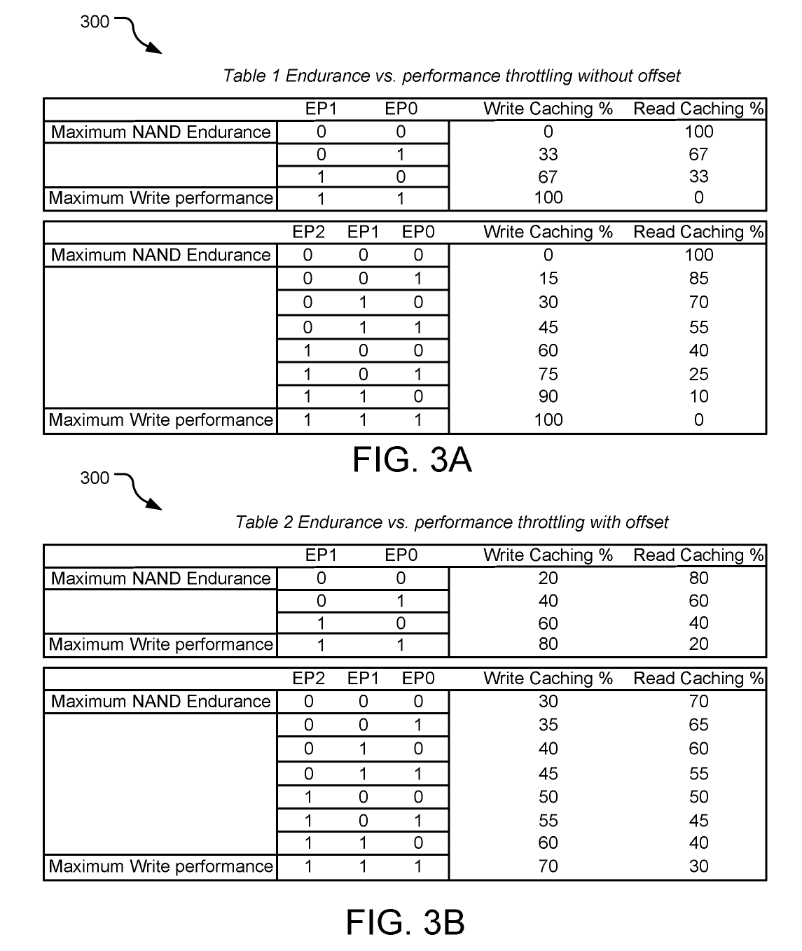

In some implementations, the adaptive caching policy may start with default minimum capacities for either read or write workload with a configurable starting minimum starting offset and incremental step size when the minimum starting offset needs to change based on learned I/O profile. An example calculation is provided and further discussed in FIG. 3.

To perform adaptive caching, the adaptive cache controller 110 receives an adaptive caching policy from the host 102 for optimally caching host read data and host write data using the NAND cache for best tradeoff between I/O performance and NAND cache media endurance. The adaptive cache controller 110 may allocate NAND cache resources for read and write data within the limits defined by this policy. The host may enable the adaptive caching algorithm to self-determine these limits and if this is allowed by host the adaptive caching controller will dynamically determine these limits based on real time workload profiling.

If the adaptive cache controller 110 is allowed to dynamically determine and reallocate caching resources limits, upon determining that the unit time (e.g., 15 minutes) for a current I/O profile has completed, the adaptive cache controller 110 may analyze the I/O profiles received in past unit time interval, and compare the new I/O profile with a currently set I/O profile. The adaptive cache storage controller 110 determines whether the new I/O profile has changed, or is different than the current I/O profile. If the new I/O profile is different, a new adaptive caching policy may be applied. If the new I/O profile has not changed, or is not different, the adaptive cache storage controller allocates read cache 150 for the host read data and write cache 152 for the host write data in the NAND cache based on the current adaptive caching policy.

Data can be serviced via different data paths in the adaptive cache controller system 100. As shown in FIG. 1, adaptive cache controller 110 will implement three types of data paths 110. The first data path, depicted as “Data Path 1,” provides for the host read and write data accessed from and to the NAND cache 112. This is the fastest path to achieve maximum performance. The second data path, depicted as “Data Path 2,” provides direct access to host 102 for read/write data to/from HDD 114 completely bypassing the NAND cache 112. The third data path, depicted as “Data Path 3,” facilitates the adaptive cache controller 110 managing cache promote and demote operations between the NAND cache 112 and HDD 114.

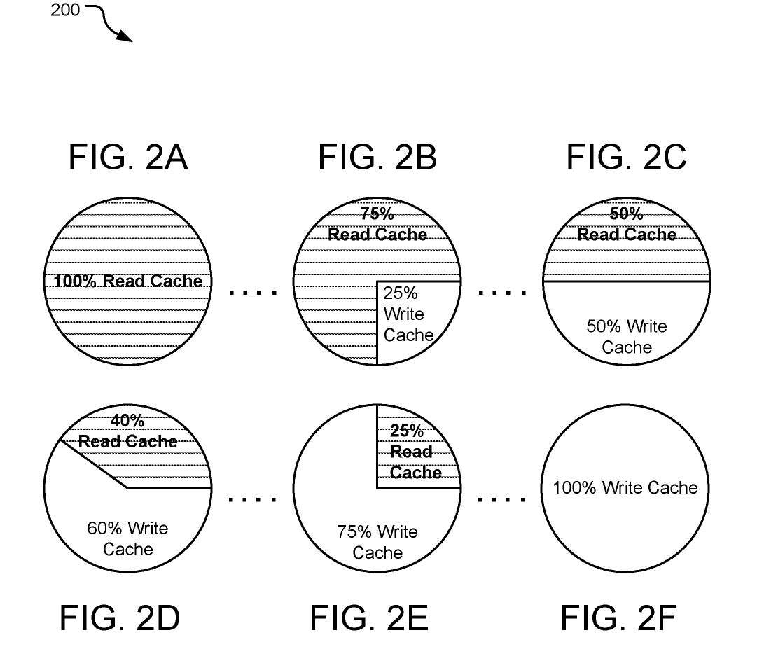

FIGS. 2A-F are schematic diagrams illustrating example NAND cache capacity management operations. In the disclosed technology, the host can override the percentage of the overall available NAND cache capacity for caching purposes. The NAND cache may be divided into two sections: 1) host read caching; and 2) host write caching.

As shown in FIG. 2A, the host may determine that the NAND cache capacity distribution should be 100% read cache. In some implementations, as shown in FIG. 2B, the host may determine that the NAND cache capacity distribution should be 75% read cache and 25% write cache. In some implementations, as shown in FIG. 2C, the host may determine that the NAND cache capacity distribution should be 50% read cache and 50% write cache.

In some implementations, as shown in FIG. 2D, the host may determine that the NAND cache capacity distribution should be 40% read cache and 60% write cache. In some implementations, as shown in FIG. 2E, the host may determine that the NAND cache capacity distribution should be 25% read cache and 75% write cache. In some implementations, as shown in FIG. 2F, the host may determine that the NAND cache capacity distribution should be or 100% write cache. Other NAND cache distributions are contemplated.

FIGS. 3A and 3B are tables illustrating endurance vs. performance throttling without and with offset. A host and/or adaptive caching controller can allocate NAND capacity in an adaptive caching operation using EP[n:0] bits for desired cache allocation for read and write IOs and Starting Offset and Step-size for EP[n:0] binary encode.

The adaptive caching operation may implement a configuration field (e.g., EP[n:0], step-size and offset fields). The EP field includes a number of steps. The step field includes the % step. The offset field can take a value from 0 to 100%. The EP, offset and the step percentage of the cache utilization can be configurable by the host. By default, the hybrid drive can have some initial settings for these fields. The following formulas compute the percentage of read and write cache utilization:

% of write cache utilization=% of offset+(EP[n:0]*step-size)

% of read cache utilization=100%−% of write cache utilization

Within each type of workload (e.g., write/read), an adaptive cache controller can determine which type of write/read I/O to be cached (e.g., random or sequential or I/O with a specific size as the host uses this I/O size the most in system). In some implementations, the value of n of EP[n:0] can vary. As shown in FIGS. 3A and 3B, the value of n may be 0, 1, or 2. Each variation has a different number of configurations which determines an exact percentage of host data traffic flowing via NAND cache.

The host may configure endurance and write caching choices per drive. For example, in case of the maximum NAND endurance is desired, the drive may operate in a non-cache mode and all write data accesses are directed to an HDD (see FIG. 3A, EP0, EP1, and EP2=0). While in the case of the maximum performance, all the write data accesses are via NAND cache (see FIG. 3A, EP0, EP1, and EP2=1).

If enabled, an adaptive cache controller may dynamically profile I/Os and based on workload characteristics decide an optimal NAND endurance vs. performance tradeoff policy as there may be certain period of time during which workload have more write I/Os vs. read I/Os, prioritizing more write caching for performance and at other time less write I/Os than read I/Os, prioritizing NAND endurance vs. performance.

FIG. 4A-4C illustrates example schematic diagrams of I/O profiling classification. The I/O profiling of host traffic is required to determine percentages of read and write cache utilization. I/O profiling includes classifying read and write commands (as shown in FIG. 4A) issued by a system host into “buckets” of different burst categories of random and sequential operations (as shown in FIG. 4B). The 4, 8, 16, 64 and 128 KB payloads shown in FIG. 4B are provided as examples, however, such payloads can vary depending on the hybrid drive system.

A more detailed classification may be derived from the two classifications of commands and burst categories (shown in FIGS. 4A and 4B), as shown in FIG. 4C. In some implementations, the I/O profiling operation includes classifying read and write commands into different burst categories. The burst categories may include at least one of random operations, sequential operations, and a combination of random and sequential operations.

Statistics are maintained to count different buckets per read/write commands per unit time (e.g., per minute). Such ‘intelligent’ I/O profile monitoring mechanism aids allocation of optimal caching resources to the I/O type and buckets which are the most dominant in a particular workload that the drive is experiencing and redirect less important workloads to main storage bypassing cache when multiple commands are outstanding in a drive and the drive needs to determine how to optimally serve those I/Os. The statistics are collected per unit time as per host configuration. The unit time can either be defined by system host or adaptively decided by adaptive operation.

In some implementations, the I/O profiling may also characterize an SSD into one of the following workload profiles: 1) pure random; 2) pure sequential; and 3) mixed. Such workload profiles are provided as example broad categories. In some implementations, an I/O profile history log from drive may be presented to the host at a regular interval. Thus, a host may recognize a drive I/O profile in collaboration with the drive during a specified time period (e.g., say a day, week or month). A host may have either configured adaptive cache controller for maximum I/O performance at the start of a day, however, the host may learn during the I/O profiling operation by reviewing the log history presented by the SSD drive and update drive setting accordingly.

In a storage system, a host may not have capability to know an individual drive I/O profile that drive experience and generally the host looks at an I/O profile across storage volume. This leads to more complex and costly host system design as workload across storage volume will be more complex than the workload at individual drive experiences. The adaptive cache controller or host can use the I/O profile learning and tailor the right caching configurations. An I/O profile log history may be presented to the host, and the host selects the appropriate configurations for a caching policy or the host may allow the adaptive caching controller to tune caching configuration dynamically in real time.

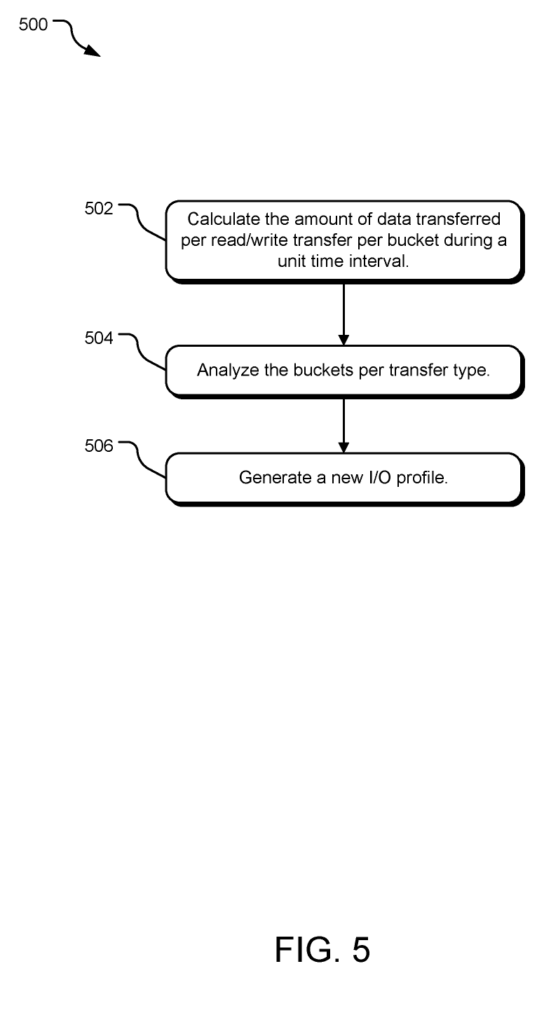

FIG. 5 is a flow chart of example operations 500 for I/O profiling. An operation 502 calculates the amount of data transferred per read/write transfer per bucket during a unit time interval. Every transfer completed host command is logged depending on its bucket size and transfer payload size.

At the end of the unit time interval, an operation 504 analyzes the I/O profile per bucket per the transfer type (e.g., read/write operation). The IDLE bandwidth is computed by deducting the actual payload transferred from the known maximum bandwidth the storage drive can deliver within the unit time window.

An operation 506 generates a new I/O profile. The new I/O profile can be used to adjust the percentage of caching proportions per unit time in comparison to a currently set caching configuration. A time interval unit (e.g., 15 minutes) may be predetermined and can be changed to any value as desired by a system host.

There may be several factors that impact caching decisions and usage. In a first example, a host determines an adaptive caching policy for an SSHD drive and the policy is configurable (e.g., for 50% endurance settings, 50% host reads and writes may be diverted via NAND cache and the remaining read and write commands may be diverted via direct HDD-access. A host can provide the range of endurance from 30% to 50%, for example. Traffic may be diverted 50-70% via NAND cache and the remaining read and write commands may be diverted via direct HDD-accesses, for example.

The adaptive caching policies may consider several factors to vary the caching resource allocation and utilization. In one example, the host may provide weightage to endurance and performance attributes for a drive to achieve optimal caching behavior for a target storage application and cost. In another example, where cost is more important, endurance attribute will have a higher weightage than performance attribute. In such case caching operation will do more read caching than write caching. In such a case, write performance may be affected but the overall caching solution cost can be minimized.

In yet another example, if the host provides more weightage for performance then caching operation will do both read and write caching based on workload profile learned by adaptive caching operation however the NAND cache endurance may be compromised for performance. For a balanced approach where both endurance and performance have equal weightage, an adaptive caching method may make intelligent determinations about write and read caching based on learned I/O profile in the unit time.

A second example of a factor that impacts caching decisions and usage is a hot/warm/cold data hint received from host. If provided, such host data hints can override adaptive controller caching decisions. The host hinted I/Os are handled as per the hints provided in the I/O commands bypassing the adaptive cache controller. Such behavior may be required to greater system flexibility as host may issue some I/Os which are performance critical but such I/Os may not occur frequently in a system if the adaptive cache controller does not provide priority.

Alternatively, the auto-tiering mechanism may create three layers, for example, hot, warm, and cold layers. The intelligence in that algorithm marks the mapping of temperature bands with respect to the LBA ranges of the data transfers coming from the host. For example, if an auto-tiering algorithm has recognized that the LBA ranges from 0 to 10 falls into a hot band; 11 to 20 in warm band and 21 to 50 in cold band. Additionally, if a host has imposed a policy to go with highest endurance. If there is a circumstance, where the host performs more hot data transfers than warm or cold transfers. To honor this policy if the adaptive caching algorithm does not allow caching even though the data falls under hot band, it will be a mistake. Because adaptive cashing algorithm does know tiering information. In such cases the auto-tiering algorithm plays important role and provides hints to the adaptive caching algorithm to cache the hot/warm data.

A third example of a factor that impacts caching decisions and usage is “idle bandwidth.” If a system is seeing reduced I/O traffic (e.g., during night time), the data transferred per unit interval time over multiple successive unit times may decrease and the storage system may not be needed to run at peak performance level even if configured for maximum performance and moderate/low endurance. During such time, the adaptive controller may still decide to bypass the NAND cache path to further save on NAND endurance while still maintaining acceptable performance. In such a situation, a host I/O may be directed to and from HDD bypassing caching resources.

For example, the adaptive caching algorithm may have computed that a 20% caching policy needs to be applied after reviewing the past history. If the data transfer from the host is negligible, then a near IDLE operation occurs and it falls under a cold band. The adaptive caching algorithm by definition will still attempt to perform 20% caching, however, it is not necessary. In such case, the algorithm can make 0% caching and let the performance degrade in such circumstances save the NAND flash endurance.

A fourth example of a factor that impact caching decisions and usage is workload profile (e.g., pure random, pure sequential, mixed). The adaptive cache controller can dynamically adapt the caching behavior depending on the nature of data in various buckets of block size. For example, a workload having significant random data may prefer to cache the host accesses around 4 KB to 16 KB buckets and direct other I/Os directly to/from an HDD for buckets more than 16 KB. In another example of workload having significant sequential workload, host accesses spanning more than 64 to 128 KB may be cached while other I/Os containing data block size other than 64 to 128 KB directed to HDD. The host and adaptive cache controller may work together to set an individual drive caching behavior in order to get optimal balance between performance and storage cost (NAND endurance).

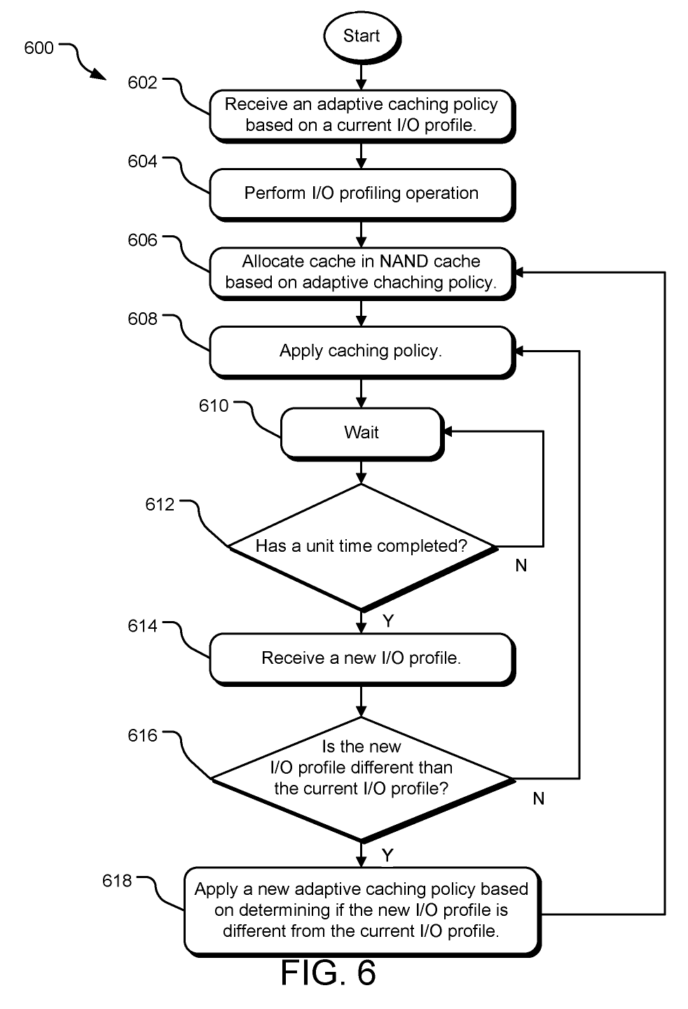

FIG. 6 is a flow chart of example operations 600 for adaptive caching. An operation 602 receives an adaptive caching policy from a host for caching host read data and host write data using NAND cache. In some implementations, the adaptive caching policy may be based on a current I/O profile. Specifically, the adaptive caching policy may be based on read and write caching capacities or a percentage of read and write transfers via cache.

An operation 604 iteratively performs an I/O profiling operation to generate an I/O profile. An operation 606 allocates read cache for the host read data and write cache for the host write data in the NAND cache based on the adaptive caching policy. Allocation of data can be provided via different data paths. For example, a first data path may connect the host and the NAND cache and provide the host with access to host read data and host write data in the NAND cache. In another example, a second data path may connect the host and the HDD and provide the host access host read data and host write data in the HDD. In yet another example, a third data path may connect the HDD and the NAND cache for at least one of a data promote operation and a data demote operation.

An operation 608 applies an adaptive caching policy based on the I/O profile. An operation 610 waits for a predetermined period of time.

An operation 612 determines when a unit time has completed (e.g., 15 minutes). An operation 614 receives a new I/O profile if the unit time has completed. If the unit time has not completed, operation 610 waits for a predetermined period of time and then operation 612 is performed again.

Once operation 612 determines that a unit time has completed, an operation 614 receives a new I/O profile. An operation 616 determines whether the new I/O profile is different from a current I/O profile. If the new I/O profile and the current I/O profile are different, an operation 618 applies a new adaptive caching policy based on the new I/O profile, and the operations can continue at operation 608, which applies the new caching policy. If the new I/O profile and the current I/O profile are not significantly different, operation 606 continues with the present caching settings.

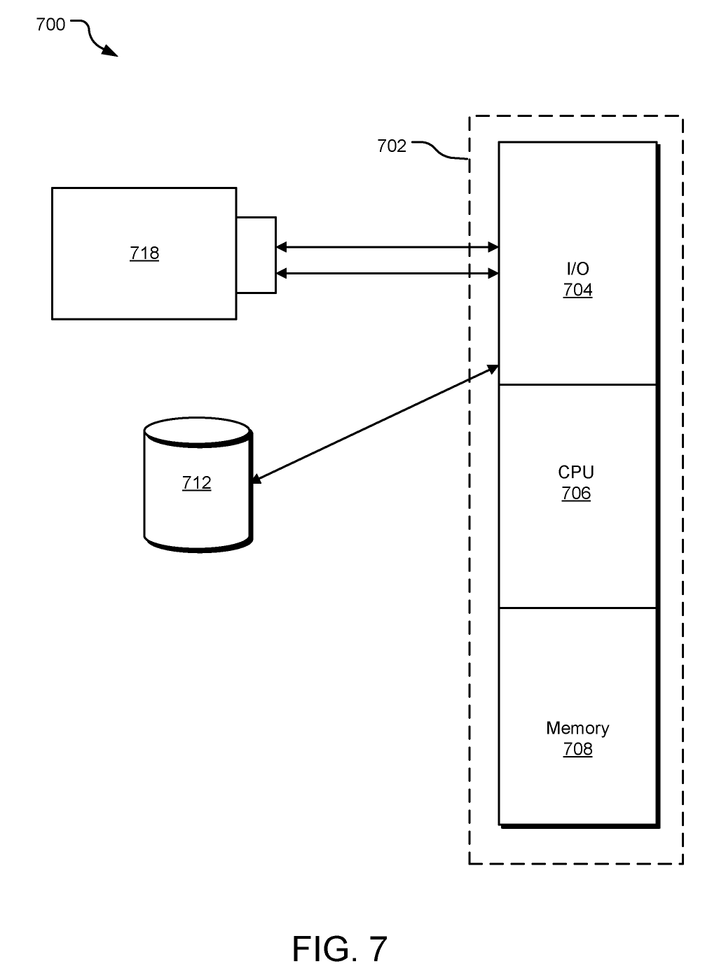

FIG. 7 illustrates a block diagram of an example computer system suitable for implementing the adaptive caching technology disclosed herein. The computer system 700 is capable of executing a computer program product embodied in a tangible computer-readable storage medium to execute a computer process. Data and program files may be input to the computer system 700, which reads the files and executes the programs therein using one or more processors. Some of the elements of a computer system 500 are shown in FIG. 5 wherein a processor 702 is shown having an input/output (I/O) section 704, a Central Processing Unit (CPU) 706, and a memory section 708. There may be one or more processors 702, such that the processor 702 of the computing system 700 comprises a single central-processing unit 706, or a plurality of processing units. The processors may be single core or multi-core processors. The computing system 700 may be a conventional computer, a distributed computer, or any other type of computer. The described technology is optionally implemented in software loaded in memory 708, a disc storage unit 712 or removable memory 718.

In an example implementation, the disclosed adaptive caching process may be embodied by instructions stored in memory 708 and/or disc storage unit 712 and executed by CPU 706. Further, local computing system, remote data sources and/or services, and other associated logic represent firmware, hardware, and/or software which may be configured to adaptively distribute workload tasks to improve system performance. The disclosed methods may be implemented using a general purpose computer and specialized software (such as a server executing service software), and a special purpose computing system and specialized software (such as a mobile device or network appliance executing service software), or other computing configurations. In addition, program data, such as dynamic allocation threshold requirements and other information may be stored in memory 708 and/or disc storage unit 712 and executed by processor 702.

For purposes of this description and meaning of the claims, the term “memory” means a tangible data storage device, including non-volatile memories (such as flash memory and the like) and volatile memories (such as dynamic random access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

The embodiments described herein are implemented as logical steps in one or more computer systems. The logical operations of the embodiments described herein are implemented (1) as a sequence of processor-implemented steps executing in one or more computer systems and (2) as interconnected machine or circuit modules within one or more computer systems. The implementation is a matter of choice, dependent on the performance requirements of the computer system implementing embodiments described herein. Accordingly, the logical operations making up the embodiments described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of example embodiments described herein. Since many alternate embodiments can be made without departing from the spirit and scope of the embodiments described herein, the invention resides in the claims hereinafter appended. Furthermore, structural features of the different embodiments may be combined in yet another embodiment without departing from the recited claims. The implementations described above and other implementations are within the scope of the following claims.

What is claimed is:

1. A method comprising:
receiving an adaptive caching policy from a host for caching host read data and host write data using NAND cache in a hybrid drive system; and
allocating read cache for the host read data and write cache for the host write data in the NAND cache based on the adaptive caching policy.

2. The method of claim 1, further comprising:
providing a first direct data path between the host and the NAND cache for the host to access host read data and host write data in the NAND cache.

3. The method of claim 1, further comprising:
providing a second direct data path between the host and a hard disc drive (HDD) for the host to access host read data and host write data in the HDD.

4. The method of claim 1, further comprising:
providing a third direct data path between a hard disc drive and the NAND cache for at least one of a data promote operation and a data demote operation.

5. The method of claim 1, further comprising:
iteratively performing an input/output (I/O) profiling operation to generate an I/O profile; and
applying the adaptive caching policy based on the I/O profile until a unit time has completed.

6. The method of claim 5, further comprising:
classifying read and write commands into different burst categories to determine required command workloads.

7. The method of claim 5, further comprising:
comparing a new I/O profile with a current I/O profile upon determining that the unit time for the current I/O profile has completed;
determining whether the new I/O profile has changed; and
applying a new adaptive caching policy based on determining the new I/O profile has changed.

8. The method of claim 7, further comprising:
allocating read and write cache utilization based on the current adaptive caching policies based on determining the new I/O profile has not changed.

9. A system comprising:
a solid-state hybrid drive (SSHD) including a hard disc drive (HDD) and a solid-state drive (SSD) including NAND cache and an SSD controller; and
an adaptive cache storage controller configured within the SSD controller and configured to:
receive an adaptive caching policy from a host for caching host read data and host write data using the NAND cache;
allocate read cache for the host read data and write cache for the host write data in the NAND cache based on the adaptive caching policy;
iteratively perform an input/output (I/O) profiling operation to generate an I/O profile; and
apply the adaptive caching policy based on the I/O profile until a unit time has completed.

10. The system of claim 9, wherein the adaptive cache storage controller is further configured to:
provide a first direct data path between the host and the NAND cache for the host to access host read data and host write data in the NAND cache.

11. The system of claim 9, wherein the adaptive cache storage controller is further configured to:
provide a second direct data path between the host and the HDD for the host to access host read data and host write data in the HDD.

12. The system of claim 9, wherein the adaptive cache storage controller is further configured to:
provide a third direct data path between the HDD and the NAND cache for at least one of a data promote operation and a data demote operation.

13. The system of claim 9, wherein the I/O profiling operation includes classifying read and write commands into different burst categories.

14. The system of claim 9, wherein the adaptive cache storage controller is further configured to:
compare a new I/O profile with a current I/O profile upon determining that the unit time for the current I/O profile has completed;
determine whether the new I/O profile has changed; and
apply a new adaptive caching policy based on determining the new I/O profile has changed.

15. The system of claim 14, wherein the adaptive cache storage controller is further configured to:
allocate read cache for the host read data and write cache for the host write data in the NAND cache based on a current adaptive caching policy responsive to determining the new I/O profile has not changed.

16. A computer-readable storage medium encoding a computer program for executing a computer process on a computer system, the computer process comprising:
receiving an adaptive caching policy for a NAND cache from a host; and
allocating read cache and write cache with an adaptive cache controller in a hybrid drive system based on the adaptive caching policy.

17. The computer-readable storage medium of claim 16, wherein the hybrid drive system includes at least one of a hard disk drive, a solid-state hybrid drive, a solid-state drive, a PCI express solid-state drive, a Serial ATA, and an interface.

18. The computer-readable storage medium of claim 16, further comprising:
iteratively performing an input/output (I/O) profiling operation to generate an I/O profile; and
applying an adaptive caching policy based on the I/O profile until a unit time has completed.

19. The computer-readable storage medium of claim 18, further comprising:
comparing a new I/O profile with the current I/O profile upon determining that the unit time has completed;
determining whether the new I/O profile has changed; and
applying new adaptive caching policies based on determining the new I/O profile has changed.

20. The computer-readable storage medium of claim 19, further comprising:
allocating read and write cache utilization based on the current adaptive caching policy based on determining the new I/O profile has not changed.
